(19) United States
(12) Patent Application Publication
(10) Pub. No.: US 2007/0001914 A1
(43) Pub. Date: Jan. 4, 2007

(54) Method and apparatus for incorporating an antenna on a vehicle

(75) Inventors: James Robnett, Bloomfield, MI (US); Mario Ganchev Gachev, Sofia (BG)

Correspondence Address: BANNER & WITCOFF, 1001 G STREET N W, SUITE 1100, WASHINGTON, DC, 20001, US

(73) Assignee: RaySat, Inc., Vienna, VA (US)

(21) Appl. No.: 11/355,291

(22) Filed: Feb. 16, 2006

Related U.S. Application Data
(63) Continuation-in-part of application No. 11/324,755, filed on Jan. 4, 2006.
(63) Continuation-in-part of application No. 11/074,754, filed on Mar. 9, 2005.
(63) Continuation-in-part of application No. PCT/US06/04040, filed on Feb. 7, 2006.
(63) Continuation-in-part of application No. 10/925,937, filed on Aug. 26, 2004.
(63) Continuation-in-part of application No. 11/071,440, filed on Mar. 4, 2005.
(63) Continuation-in-part of application No. 11/320,805, filed on Dec. 30, 2005.
(63) Continuation-in-part of application No. PCT/US05/28507, filed on Aug. 10, 2005.
(63) Continuation-in-part of application No. 11/354,246, filed on Feb. 15, 2006.
(60) Provisional application No. 60/653,520, filed on Feb. 17, 2005.

(51) Int. Cl. H01Q 1/32

(52) U.S. Cl. 343/713

(57) ABSTRACT

A method, apparatus, and system for incorporating an antenna on a vehicle, allowing the reception of satellite television and other data to a vehicle.

### BACKGROUND OF THE INVENTION

1. Related Application

The present application is a continuation application of U.S. Provisional Application No. 60/653,520 filed Feb. 17, 2005, titled Method and Apparatus For Incorporating An Antenna On A Vehicle, herein incorporated by reference in its entirety. The present invention is also a continuation-in-part of U.S. application Ser. No. ______/______,______, Filed Feb. 15, 2006, entitled Method and Apparatus for Providing Satellite Television and other Data to Mobile Antennas, attorney docket no. 006681.00076, U.S. application Ser. No. 11/324,755, filed Jan. 4, 2006, entitled System and Method for Low Cost Mobile TV, U.S. application Ser. No. 10/752,088, filed Jan. 7, 2004, entitled Mobile Antenna System for Satellite Communications, U.S. application Ser. No. 11/183,007 filed Jul. 18, 2005, entitled Mobile Antenna System for Satellite Communications, U.S. application Ser. No. 11/074,754, filed Mar. 9, 2005, entitled Method and Apparatus for Providing Low Bit Rate Satellite Television To Moving Vehicles, U.S. application Ser. No. 10/925,937, filed Aug. 26, 2004, entitled System For Concurrent Mobile Two-way Data Communications and TV Reception, U.S. application Ser. No. 11/071,440, filed Mar. 4, 2005, entitled Low Cost Indoor Test Facility and Method for Mobile Satellite Antennas, U.S. application Ser. No. ______/______,______ filed Sep. 6, 2005, entitled Tracking System for Flat Mobile Antenna (PCT/BG2004/000004 filing in U.S. under §371), U.S. application Ser. No. ______/______,______ filed Sep. 6, 2005, entitled Flat Mobile Antenna System (PCT/BG2004/000003 filing in U.S. under §371), U.S. application Ser. No. 10/752,088, filed Jan. 7, 2004, entitled Mobile Antenna System for Satellite Communications, U.S. application Ser. No. 11/183,007, filed Jul. 18, 2005, entitled Mobile Antenna System for Satellite Communications, U.S. application Ser. No. ______/______,______, filed Oct. 25, 2005, entitled Digital Phase Shifter (PCT/BG2004/000008 filing in U.S. under §371), International Application Ser. No. PCT/BG2004/00011, entitled Flat Microwave Antenna, Filed Jul. 7, 2003, U.S. application Ser. No. 10/498,668, Filed Jun. 10, 2004, entitled Antenna Element, U.S. application Ser. No. ______/______,______, (Attorney Docket No. 006681.00070) filed Dec. 30, 2005, entitled Applications for Low Profile Two Way Satellite Antenna System, each of the foregoing applications is hereby specifically incorporated by reference in their entirety herein. With respect to any definitions or defined terms used in the claims herein, to the extent that terms are defined more narrowly in the applications incorporated by reference with respect to how the terms are defined in this application, the definitions in this application shall control.

2. Field of the Invention

The present invention relates to a method, apparatus, and system for incorporating an antenna on a vehicle, allowing the reception of satellite television and other data to a vehicle.

### SUMMARY OF THE INVENTION

It is desirable to have the ability to receive satellite television and other data at a vehicle. Heretofore, it has not been practical due to the large sizes of antennas. Problems associated with incorporation of an antenna capable of receiving satellite television and other data on a vehicle include:

loss of sun roof functionality;

loss of a normal roofline (too big, bulky); and

loss of ability to store skis or other luggage on roof.

The inventor has found novel approaches to incorporate an antenna on a vehicle, allowing the reception of satellite television and other data to a vehicle.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an exemplary embodiment of the invention incorporating an antenna as part of a retractable sunroof;

FIG. 2 illustrates an exemplary embodiment of the invention incorporating an antenna as part of pop-up or hide-away feature;

FIG. 3 illustrates an exemplary embodiment of the invention incorporating an antenna with a “scissors”-type lift mechanism; and

FIG. 4 illustrates an exemplary embodiment of the invention incorporating an antenna as part of a roof-box or rack.

### DETAILED DESCRIPTION OF EXEMPLARY EMBODIMENTS OF THE PRESENT INVENTION

Illustrative, non-limiting embodiments of the present invention may overcome one or more of the above disadvantages and other disadvantages not described above. Although aspects of the present invention are not required to overcome the disadvantages described above, an illustrative, non-limiting embodiment of the present invention may not overcome one or more of the problems described above.

The present invention relates to incorporation of an antenna on a vehicle to allow for satellite TV and data service. The invention directed at vehicles (e.g., cars) including aftermarket and original equipment manufacturers (OEM).

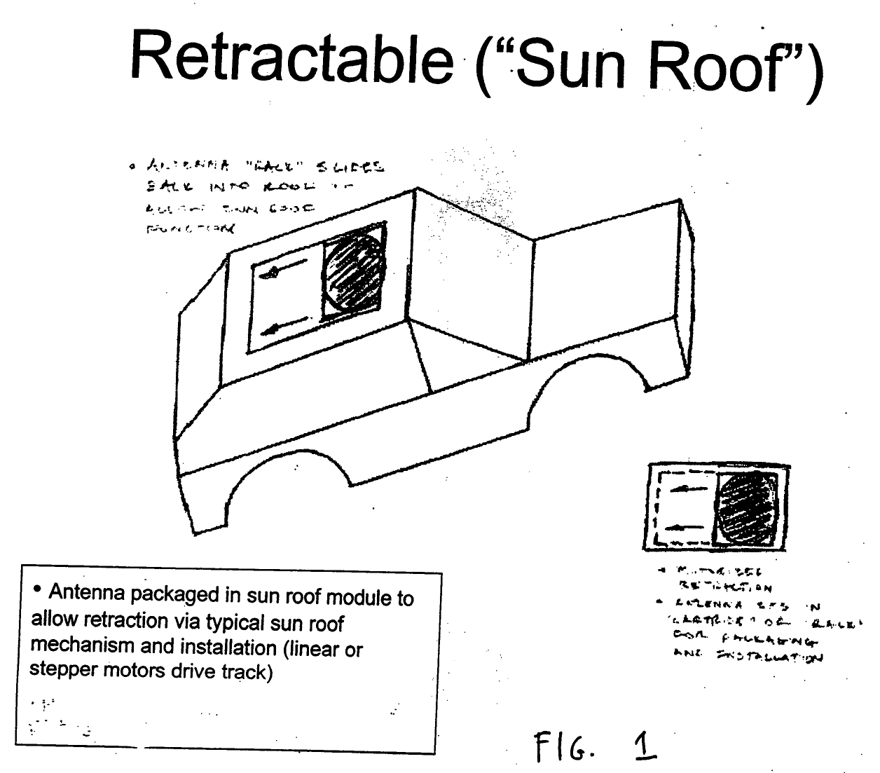

FIG. 1 illustrates a first exemplary embodiment of the invention. In FIG. 1, an antenna acts as a sunroof, allowing light into the vehicle compartment. In other woods, the antenna comprises at least a glass, plastic, or other material known in the art. For example, the antenna may include toughened glass between 4 and 6 mm thick with varying degrees of light transmission and solar energy absorption.

The mechanism for opening and closing the “sunroof” antenna may allow retraction via a related art sun roof mechanism and installation (for example, linear or stepper motor drive tract).

As an alternative embodiment, the antenna may be incorporated into a related art sunroof package, thus having both the conventional sunroof, and the antenna disposed above or below the sunroof. This embodiment, however, would add “thickness” to the sunroof package.

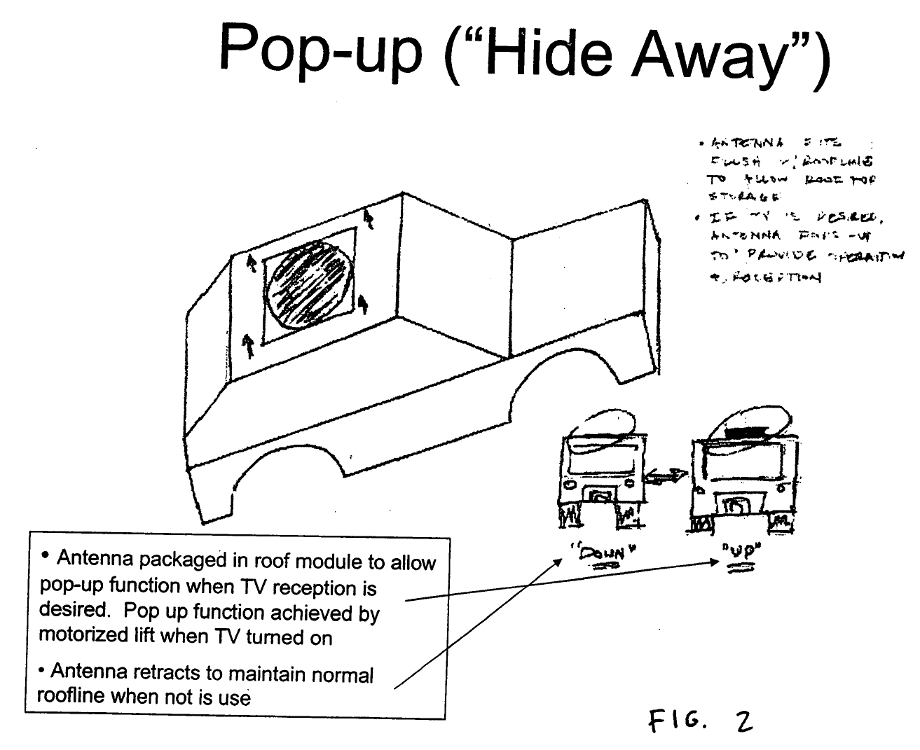

FIG. 2 illustrates a second exemplary embodiment of the invention. In FIG. 2, an antenna is packaged in a roof module to allow a “popup” function when television reception is desired. The pop-up function may be achieved, for example, by a motorized lift when a TV is turned on. When not in use, the antenna may retract to maintain a normal roofline. Alternatively, the pop-up function may be initiated manually, by a hand cranked or other mechanism.

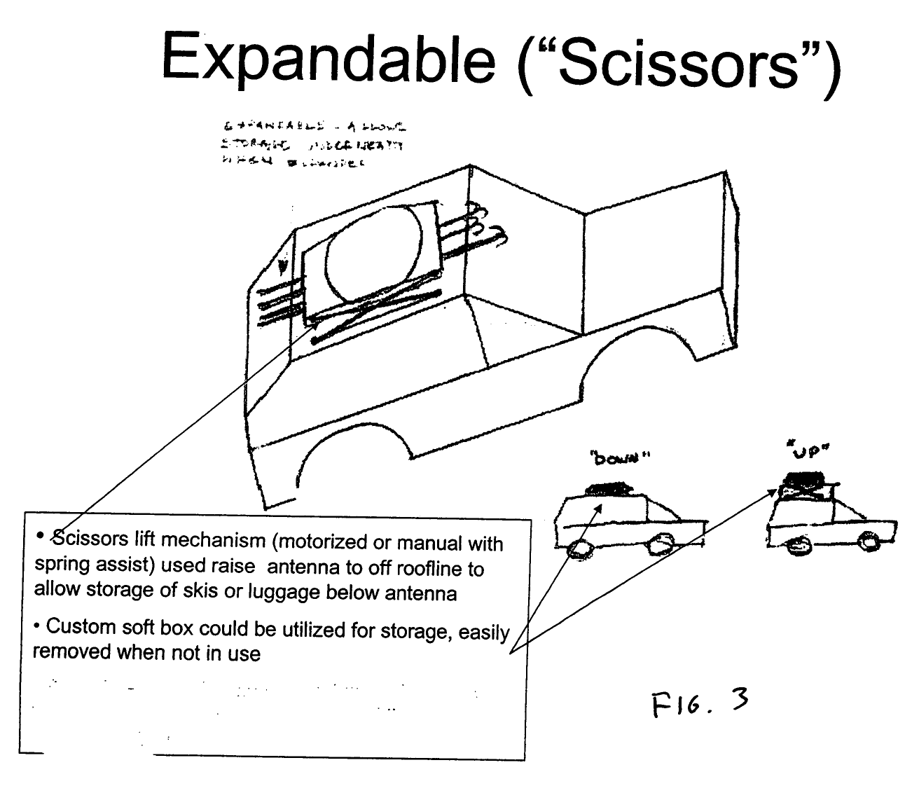

FIG. 3 illustrates a third exemplary embodiment of the invention. In FIG. 3, an antenna includes a scissors lift mechanism. The lift mechanism may be motorized or manual, for example using a spring assist to raise the antenna off of the roofline. This embodiment facilitates the storage of skis or luggage below the antenna. Additionally, a custom soft box may be utilized for storage, and easily removed when not in use.

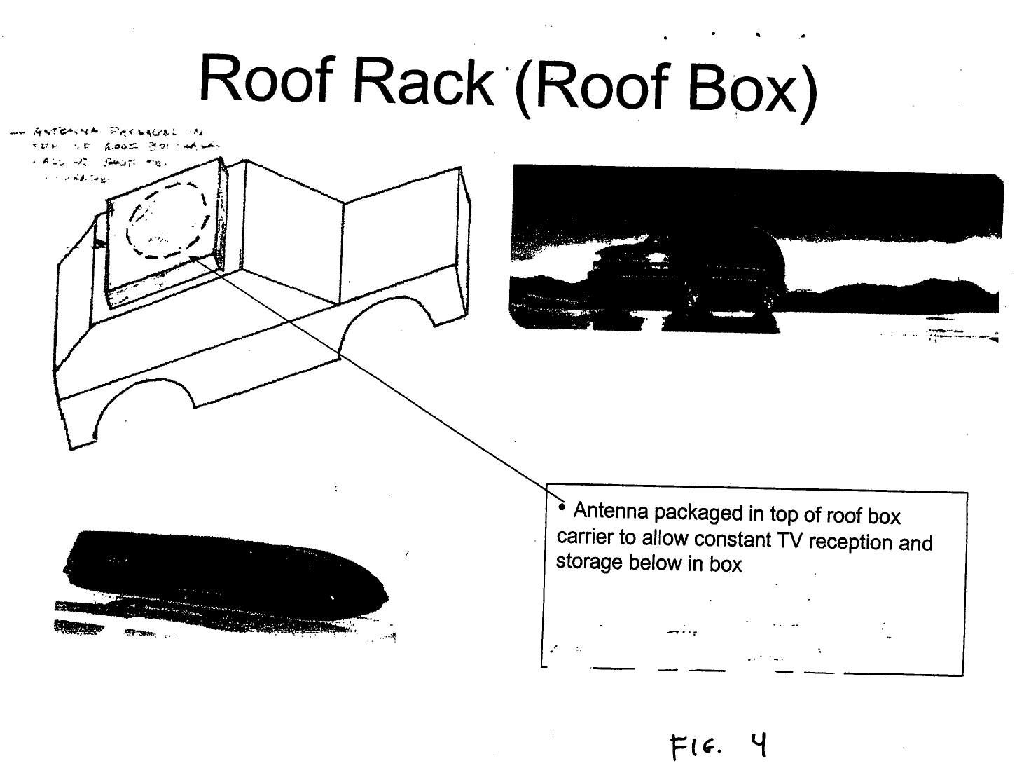

FIG. 4 illustrates a fourth exemplary embodiment of the invention. In FIG. 4, an antenna may be packaged on top of a roof box carrier to allow constant TV reception and storage below in the box.

An antenna of the invention may comprise, in an exemplary embodiment a small antenna, for example, one of 20 cm diameter×2.5 cm high. The antenna may include:

1-4 TV channels per transponder;

use of inclined orbit satellites, “old” DTH satellites;

remote terminals having low cost.

Sensors and a tracking system may be provided to allow uninterrupted access to any satellite with EIRP>52 dB—while stationary or in motion.

The antenna of the present invention may also include the following features:

| | Diameter | | | | | | Beam | Number |
|---|---|---|---|---|---|---|---|---|
| | of the | Array | | FOV | | | Width | Of |
| Variant | product | aperture | Height | Elevation | G/T | BitRate | Elev./Azim. | Beams |
| FES | 15 cm | 7.5 cm | 1.27 cm | 45° | −7.2 dBpK | −0.4 Mbps | 25°/25° | 135 |
| Fully Electronic | | in diameter | | 55° | −8.0 dBpK | | | |
| Steerable | | | | 65° | −8.9 dBpK | | | |
| Antenna | | | | | | | | |
| SEMA | 20 cm | 17 cm × 7.5 cm | 1.27 cm | 35° | −5.6 dBpK | 0.9 Mbps | 20°/15° | 3 |
| Semi Electronic | | | | 55° | −2.0 dBpK | 1.8 Mbps | | |
| in Elevation, | | | | 75° | −5.1 dBpK | 0.9 Mbps | | |
| Mechanical in | | | | | | | | |
| Azimuth | | | | | | | | |
| FBMA | 20 cm | 17 cm × 7.5 cm | 1.27 cm | 35° | −5.6 dBpK | 0.9 Mbps | 20°/15° | 1 |
| Fixed beam in | | | | 45° | −2.0 dBpK | 1.8 Mbps | | |
| Elevation, | | | | 55° | −5.1 dBpK | 0.9 Mbps | | |
| Mechanical in | | | | | | | | |
| Azimuth | | | | | | | | |
| FBMA | 20 cm | 17 cm × 7.5 cm | 3.3 cm | 25° | −5.6 dBpK | 0.9 Mbps | 20°/15° | 1 |
| with 10deg. | | | | 35° | −2.0 dBpK | 1.8 Mbps | | |
| Mechanical tilt | | | | 45° | −5.1 dBpK | 0.9 Mbps | | |
| Fixed beam in | | | | | | | | |
| Elevation, | | | | | | | | |
| Mechanical in | | | | | | | | |
| Azimuth | | | | | | | | |

An antenna system of the invention may also include a receiver. In one embodiment, the receiver of the system may be, for example, a simple set-top box, and reception may be based on DVB-S2 chip set or simple spread spectrum receiver (interference only from 9° or more apart). Also, the antennas of the invention may be integrated with standard receiver systems from major DTH provides such as Echostar and DirecTV.

Other antennas may also be used in exemplary embodiments. In addition to satellite television, the antennas may also act to deliver in motion high-speed Internet access to motorist and emergency personnel in their cars, trucks, motor homes and boats. As such, an antenna of the present invention may turn a car, truck, or any vehicle into a rolling “hot spot,” enabling Internet access to wireless-capable laptops, PDAs, or other devices. For example, to deliver internet access, a system of the invention may provide download speeds up to 2 mbps or more and upload speeds up to 128 kbps or more, shared between the users in the vehicle.

One antenna of the invention may be compact, and employ a five-inch high phased array antenna and provide a high reliable alternative to terrestrial based communication systems, which may fail in emergencies or not provide sufficient range in remote areas.

Further, in other exemplary embodiments of the invention the antenna may use a phased-array antenna that rotates (inside the housing). The antenna's panels constantly move up and down and back and forth, to track and maintain the satellite signal regardless of the vehicle's position relative to the satellite with which it is in communication.

In embodiments of the invention, the antenna may include dimensions of 38.5″×34.6″×1.9″; or 7.2″×8″×2″. The weight of the antenna in exemplary embodiments is 40 pounds and under. As indicate by the applications incorporated by reference herein, the antenna size may be variously configured and in some instances may be an ultra small mobile antenna. Other features may include:

Electrical

Frequency band for operation may be 12.2-12.7 GHz, with a

Polarization: linear and circular

Power supply; 12V

Power consumption: 60 Watts

Pointing System

Elevation range: 30°-90°

Azimuth range: 360°

Tracking rate: 60° degrees per second elevation,

30° degrees per second azimuth

Satellite search, recognition and tracking: Fully automated

Environmental

Temperature Range: 13° F. to 122° F.

Another embodiment of the antenna may comprise a Ku-band in motion antenna. In this embodiment, it may even be envisioned that a coexisting cellular network, may provide low-speed upload and back-up download channels in case line of sigh is temporary obstructed by hills, trees, buildings or tunnels. Features of this antenna may include:

Electrical

Frequency band: 10.75 to 12.75 GHz (optimized at 12 GHz)

Polarization: Linear and circular

Power supply; 12V DC

Power consumption: 65 Watts

Pointing System

Elevation range: 15°-75°

Azimuth range: 360°

Tracking rate: 30°/Second

Satellite search, recognition and tracking: Fully automated

In this embodiment, advanced sensors and a sophisticated tracking system provide uninterrupted access to any satellite with EIRP>52 dBW.

In concluding the detailed description, those skilled in the art will appreciate that many variations and modifications can be made to the exemplary embodiments without substantially departing from the principles of the present invention.

What claim is:

1. A mobile satellite antenna system for incorporation into a vehicle: a mobile satellite antenna disposed in a roof of a vehicle between an exterior and an interior surface of the roof.

2. The mobile satellite antenna system of claim 1 wherein the mobile satellite antenna rises vertically out of the roof.

3. The mobile satellite antenna system of claim 1 wherein an outer cover slides within the roof to expose the mobile satellite antenna.

4. The mobile satellite antenna system of claim 1 wherein a scissor lift is utilized to lift the mobile satellite antenna.

5. A mobile satellite antenna sunroof.

6. A method for incorporating a mobile satellite antenna in a car including disposing a mobile satellite antenna in a roof of a vehicle between an exterior and an interior surface of the roof.

7. A method comprising configuring a car to include a mobile satellite antenna which rises out of a space between an outer and inner surface of a vehicle roof.
